(19) United States
(12) Patent Application Publication
(10) Pub. No.: US 2024/0125514 A1
(43) Pub. Date: Apr. 18, 2024

(54) Electrical Heating Device and Method of Manufacturing the Same

(71) Applicant: Eberspächer catem GmbH & Co. KG, Herxheim (DE)

(72) Inventors: Timo Kröner, Rülzheim (DE); Simon Stuppert, Berg (DE)

(21) Appl. No.: 18/380,416

(22) Filed: Oct. 16, 2023

(30) Foreign Application Priority Data
Oct. 17, 2022 (DE) 10 2022 127 107.2

(51) Int. Cl. F24H 3/04

(52) U.S. Cl. CPC F24H 3/0464

(57) ABSTRACT

An electrical heating device for a motor vehicle includes an at least partially electrically conductive housing having an end face in which a circumferential groove is provided. A lid, formed from sheet metal, seals the housing. An adhesive is introduced into the groove The lid has a circumferential edge which engages in the groove such that the edge of the lid is immersed circumferentially in the adhesive. The inside dimension of the groove is smaller than the wall thickness of the lid.

### BACKGROUND OF THE INVENTION

### 1. Field of the Invention

The present invention relates to an electrical heating device and a method of manufacturing the same. An electrical heating device known from DE 20 2020 000 689 U1 is considered to be generic. This prior art discloses an electrical heating device with an at least partially electrically conductive housing and a lid formed of sheet metal, which seals the housing.

### 2. Background of Related Art

In particular, the present invention relates to an electrical heating device in which the housing comprises or forms a circulation chamber with inlet and outlet openings for a fluid to be heated, a PTC heating assembly connected to the circulation chamber in a heat-conducting manner with a PTC element for heating a medium in the circulation chamber, a connection chamber in which the PTC heating assembly is electrically connected, and a partition wall, wherein the partition wall separates the circulation chamber from the connection chamber in a fluid-tight manner.

In the electrical heating device according to the invention, several PTC heating assemblies are usually accommodated in the housing. Thus, several PTC heating assemblies are usually electrically connected in the connection chamber, if necessary also grouped into heating circuits. For this purpose, a printed circuit board can be provided in the connection chamber, which assigns different PTC heating assemblies to different heating circuits. The connection chamber may furthermore provide an equipped printed circuit board that is a central component of a control system, which as a rule controls the several PTC heating assemblies for appropriate power adjustment of the electrical heating device.

These details are also known from DE 20 2020 000 689 U1.

The above features may also be preferred features of the electrical heating device according to the invention.

With corresponding electrical heating devices, there is the problem of interference with other components in the environment due to electromagnetic waves, in particular when switching the PTC heating assembly. These components may include, for example, electronic components or on-board entertainment components in a vehicle. In view of this, it is known to configure the housing to be at least partially electrically conductive for the purpose of shielding. In particular, the connection chamber and the control system provided therein are housed in a metallic housing. Parts of the housing surrounding or defining the circulation chamber may be formed of an electrically non-conductive material. In respect of reduced weight, plastic is preferred.

The requirements, in particular for an electrical heating device in a motor vehicle, impose various other requirements. For example, the electrical heating device must not only be configured to save as much weight as possible. Rather, the electrical components of the electrical heating device should be reliably protected from the environment. This applies in particular to electrical heating devices for electromobility. These electrical heating devices are usually operated with high voltage. Moisture and/or dirt penetrating the connection chamber, for example, can impair the desired electrical insulation of individual components. Dirty or moistened surfaces can promote the formation of leakage currents.

The underlying problem of the present invention is to provide an electrical heating device and a method of manufacturing the same, which enables as good as possible sealing of the housing with reliable shielding of electrical components accommodated in the housing. It must be possible to carry out the proposal in a process-safe manner.

### SUMMARY

In order to solve this problem, the present invention provides an electrical heating device of the type introductorily mentioned, in which the housing has a circumferential groove on one end face. A circumferential groove in this sense is understood to be a groove which is configured circumferentially in the circumferential direction of the groove. In this context, it is not important that the groove is configured with the same depth over the entire circumference. An adhesive is introduced into the groove. This adhesive provides a seal for the lid. For this purpose, the lid has a circumferential edge which engages in the groove such that the edge of the lid is immersed circumferentially in the adhesive. This results in a fully fluid-tight seal of the lid in the area of the groove.

As an adhesive, a curing adhesive which is still elastic in the cured state is particularly suitable. For example, a silicone adhesive can be used.

The adhesive serves not only to hold the lid. The adhesive also acts as a sealing compound, preventing the passage of dirt and/or moisture in the area of the groove by the circumferential edge engaging with the adhesive.

The lid may be made of sheet metal. This formulation conveys that the material of the lid has a wall thickness predetermined by the starting material of the sheet metal. The lid may be provided by stamping and bending or other forming operations such that a circumferential edge protrudes from the otherwise basically planar cover surface of the lid substantially at right angles from a cover surface formed by the lid. The inside dimension is understood to be the dimension that results as the distance between opposing inner surfaces of the groove in a sectional view through the groove. The inside dimension is, for example, the distance between a foremost point of an inner surface of the groove lying behind the section and the opposite inner surfaces of the groove, the foremost point of which may lie in the section. Opposing contact surfaces of the groove that abut the edge of the lid are offset in the longitudinal direction of the groove. These contact surfaces are formed by projections arranged offset on opposite inner sides of the groove. In this configuration, the foremost ends of corresponding projections facing each other in a cross-sectional view define the inside dimension of the groove. The projections are generally known from CN 212 422 747 U1. In this prior art, a sealing ring is inserted into the groove, against which the front free end of the edge of the lid is to be applied in a sealing manner, for which purpose the edge is applied with pretension against the sealing element. For this purpose, the edge is to be firmly clamped in the groove via the corresponding projections. Such a function, which secures the mechanical connection between the lid and the housing, presently also has the specification that the inside dimension of the groove must be smaller than the wall thickness of the lid. However, this measure presently is proposed in connection with the concept for sealing the groove. The dimensioning of the groove relative to the wall thickness of the lid is chosen in order to scrape off the adhesive introduced into the groove on opposite edge surfaces of the edge and thus to ensure reliable electrical contact between the housing and the lid when the lid is inserted into the groove. It is understood that the groove is in any case formed by an electrically conductive portion of the housing. The scraping of the adhesive from the edge surfaces of the lid when the lid is inserted into the groove results in a solid electrical contact and thus in the completion of the shielding by the lid with a process-safe sealing of the lid against the housing.

The adhesive may be dosed volumetrically into the groove such that the adhesive basically seals the edge in the height direction of the groove in any case also where the inside dimension of the groove is smaller than the wall thickness of the lid. Thus, the adhesive also protects the contact points for electrical contact between the lid and the housing from external influences. Corrosion at the corresponding point is not a concern due to the sealing in the adhesive, so that reliable electrical contact between the lid and the housing is maintained even over a longer period of use of the electrical heating device. In addition, there is an improved connection between the lid and the housing, since not only is the lid mechanically clamped in the groove, but it is additionally secured in the groove by an at least partially cured adhesive and its adhesive properties.

According to a possible further development of the present invention, the housing is a die-cast part. The groove has opposing inner surfaces which, in a top view, have a complementary corrugated course. The channel formed in the groove between the two inner surfaces regularly has an identical width in its course. The corrugated course is provided over the entire height extension of the inner surface, namely due to the die casting of the housing. In other words, the respective corrugated contours run from the bottom of the groove to the top edge of the groove. The entrance area of the groove, i.e. the free end of the groove, can be slightly funnel-shaped to facilitate the insertion of the edge of the lid.

The corrugated course is usually configured in a uniform manner. Two depths provided on one side usually have a distance of between 10 mm and 70 mm, and more typically between 20 mm and 50 mm. In the direction of a depth formed on the one inner surface, a pitch formed on the opposite inner surface protrudes.

In the method according to the invention, the lid and the housing are prepared with the previously discussed device features. An adhesive is then introduced into the groove. The circumferential edge of the lid is inserted into the groove such that the edge is immersed circumferentially in the adhesive and, when inserted into the groove between opposing inner surfaces of the groove, the edge of the lid is deformed, thereby scraping adhesive from the metallic surface of the lid.

After the adhesive has cured, a material connection secured by the adhesive itself is created between the lid and the housing. In addition, a form-fit and/or force-fit connection is effected by the deformation of the edge of the lid in the groove. By scraping off the adhesive, a solid electrical connection between the edge of the lid and the groove is also effected circumferentially.

The present invention allows an optimal and uniform electrical connection to reduce electromagnetic radiation from electronic components within the electrical heating device. The uniform connection results from the fact that the groove and the edge run around in the circumferential direction and the groove has, at least in sections over the entire circumference, an inside dimension which is smaller than the wall thickness of the lid. This inside dimension realized over the entire circumferential direction. This results in a high number of connection points in the circumferential direction, i.e. all around the housing. Consequently, an electrical connection is created between the lid and the housing with a high total cross-section. This results in an optimal potential equalization. The edge of the lid only has to be produced by forming. The geometry of the lid including the edge can be kept very simple. The bonding realized in the groove protects the electrical contact points between the lid and the groove from environmental influences and thus corrosion.

The adhesive can be a fairly simple adhesive. Small quantities of adhesive are required, since the groove is preferably formed in the circumferential direction with a reduced inside dimension, so that only a small volume of adhesive is required to fill the groove with the adhesive. Due to the mechanical connection between the groove and the edge of the lid, the adhesive can be selected increasingly, if not exclusively, with regard to its sealing effect. In particular, it is not necessary to select the adhesive according to the best possible adhesive properties, since the mechanical fastening of the edge is already sufficient to hold the lid to the housing after pressing in the groove due to the smaller inside dimension of the groove.

### BRIEF DESCRIPTION OF THE DRAWINGS

Further details and advantages of the present invention will be apparent from the following description of an embodiment in conjunction with the drawing. Therein:

FIG. 1 shows a perspective exploded diagram of an embodiment of an electrical heating device;

FIG. 2 shows a longitudinal sectional view of a PTC heating assembly of the heating device according to FIG. 1;

FIG. 3 shows a perspective side view of a schematically shown housing with a lid;

FIG. 4 shows a longitudinal sectional view through the groove and the edge of the lid for the example according to FIG. 3, and

FIG. 5 shows a cross-sectional view through the groove and edge of the lid for the example shown in FIG. 3.

### DETAILED DESCRIPTION

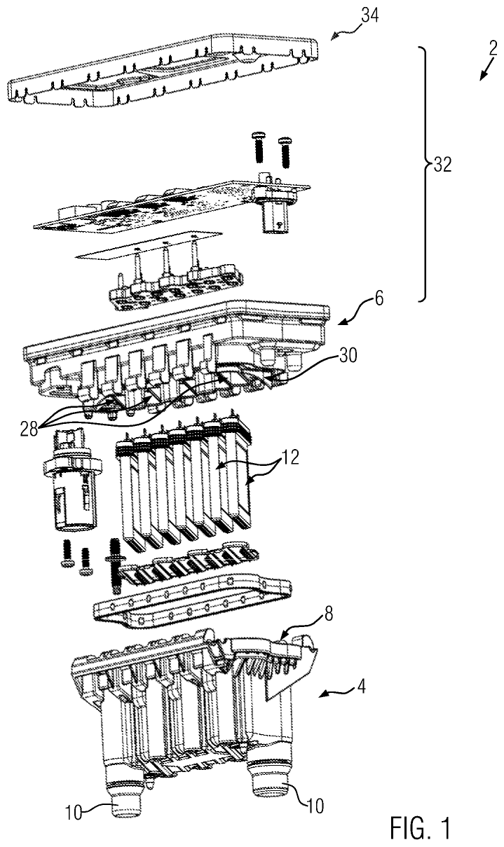

FIG. 1 shows an embodiment of an electrical heating device 2 with a multi-part heater housing comprising a housing lower part 4 formed of plastic and a housing upper part 6 integrally formed of metal by means of die casting.

The housing lower part 4 is trough-shaped and encloses a heating chamber 8 and forms inlet and outlet nozzles 10 which communicate with the heating chamber 8. These inlet and outlet nozzles 10 are integrally formed with the housing lower part 4 by injection molding. A plurality of PTC heating assemblies 12 are shown between the housing upper part 6 and the housing lower part 4.

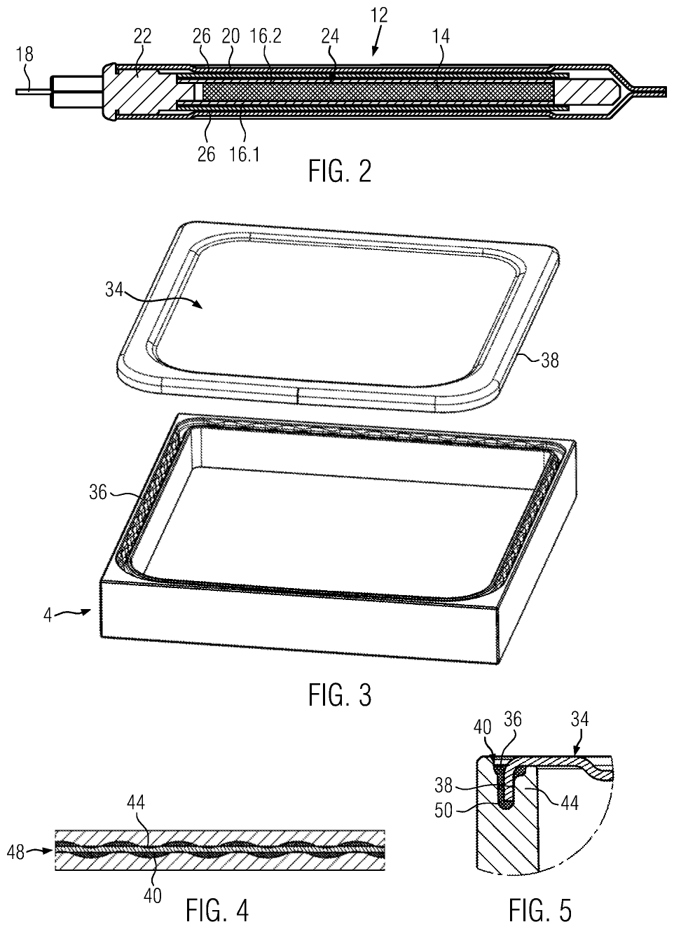

As FIG. 2 illustrates, these PTC heating assemblies 12 each have at least one PTC element 14 against which contact elements 16.1; 16.2 abut, forming contact tongues 18 which protrude beyond a metal housing 20. The PTC element 14 is accommodated in a frame 22 and between the contact elements 16.1; 16.2. Insulating layers 26 are provided between the metallic housing 20 and a heating cell 24 formed by the two contact elements 16.1; 16.2 and the PTC element 14.

The PTC heating assemblies 12 are held in plug-in contact in an accommodation 28 provided for this purpose in a partition wall 30 of the housing upper part 6 and are electrically connected and controlled in a connection chamber 29 of a control system 32. Details of this configuration are described in EP 3 334 242 A1, which originates from the applicant.

In FIGS. 1 and 3, reference sign 34 characterizes a lid which is connected to the housing upper part 6 in a sealing and electrically conductive manner. This component, also referred to as housing 20 in the following, is shown in a perspective side view in FIG. 3. It is evident that the housing 6 has a circumferential groove 36, the course of which corresponds to the geometry of an edge 38 of the lid 34. The configuration of the groove 36 can be seen in particular in FIGS. 4 and 5. As FIG. 4 illustrates, opposing inner surfaces 42, 46 of the groove 36 have a corrugated course in the top view of the groove 36. The corrugated course is complementary. Depths 40 on a first inner surface 42 are opposite to pitches 44 of the other, second inner surface 46 of the groove 36. This results in a channel characterized by reference sign 48, which has an identical width over its entire course.

FIG. 5 illustrates the arrangement of the edge 38 within the groove 36. Reference sign 50 characterizes an adhesive within the groove 36. After the edge 38 is inserted into the groove 36, the adhesive 50 is partially displaced within the groove 36. It rises within the groove 36. The adhesive 50 is dimensioned such that after the insertion of the edge 38 into the groove 36 is complete, the adhesive 50 is not displaced beyond the groove 36. The installation position of the edge 38 is reached when the front free end of the edge 38 abuts the bottom of the groove 36. As FIG. 5 illustrates, the edge of the lid 38 is in good electrical contact with the right-hand pitch 44, whereas adhesive 50 is provided on the opposite side and in the remainder of the depth 40. All spaces within the groove 36 are filled by the adhesive 50. The adhesive 50 is absent only where the edge 38 is in direct contact with the inner surfaces 42, 46 of the groove 36.

1. An electrical heating device for a motor vehicle, comprising:
an at least partially electrically conductive housing having a circumferential groove provided on an end face thereof,
a lid which seals the housing, the lid being formed from sheet metal, wherein an adhesive is introduced into the groove, wherein the lid has a circumferential edge which engages in the groove such that the edge of the lid is immersed circumferentially in the adhesive, and wherein an inside dimension of the groove is smaller than a wall thickness of the lid.

2. The electrical heating device according to claim 1, wherein opposing inner surfaces of the groove have projections which are arranged in an offset manner in a longitudinal direction of the groove.

3. The electrical heating device according to claim 1, wherein the housing is a die-cast part, and wherein opposing inner surfaces of the groove have a complementary corrugated course in a top view.

4. A method of manufacturing an electrical heating device for a motor vehicle, comprising:
providing an at least partially electrically conductive housing and a lid, the lid being formed from sheet metal with a circumferential edge, a circumferential groove being formed on one end face of the housing, the inside dimension of which is smaller than a wall thickness of the edge;
introducing an adhesive into the groove; and
introducing the circumferential edge into the groove such that the edge is immersed circumferentially in the adhesive and is deformed between opposing inner surfaces of the groove during introduction into the groove.
